(19) United States
(12) Patent Application Publication
(10) Pub. No.: US 2017/0255749 A1
(43) Pub. Date: Sep. 7, 2017

(54) Systems and Methods for Receiving and Condensing a Plurality of Medical Records

(71) Applicants: Reed Pyers, Frankfort, KY (US); Tyler Franz, Charlotte, NC (US)

(72) Inventors: Reed Pyers, Frankfort, KY (US); Tyler Franz, Charlotte, NC (US)

(21) Appl. No.: 15/432,895

(22) Filed: Feb. 14, 2017

Related U.S. Application Data
(60) Provisional application No. 62/295,345, filed on Feb. 15, 2016.

(51) Int. Cl. G06F 19/00; G06F 17/30

(52) U.S. Cl. CPC G06F 19/322; G06F 17/30867; G06F 19/3431

(57) ABSTRACT

A networked system is designed to distribute a first person's first health care record to a plurality of second health care providers to facilitate receipt of a plurality of second health care records including, for example, the second opinions of the plurality of second health care providers. The networked system is further designed to create a third health care record based on at least a portion of the plurality of second health care records. The networked system includes an intermediary server for performing some or all of its operations.

### CROSS REFERENCE TO RELATED APPLICATIONS

This application claims the benefit of U.S. Provisional Application No. 62/295,345 filed Feb. 15, 2016.

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally speaking, this application describes systems and methods for distributing a person's first health care record to a plurality of health care providers to facilitate the receipt of a plurality of second health care records, such as the “second opinions” of health care providers that are specialists in a particular health care field. The systems and methods described in this application may further create a third health care record based on at least a portion of the received plurality of second health care records.

In the field of health care, many medical conditions are difficult to diagnose. In many cases, this results in high rates of misdiagnosis. Moreover, for any given diagnosed medical condition, the recommended treatments suggested by different health care providers may vary. Accordingly, a person may not have confidence in the medical opinion of their first health care provider, including the first health care provider's diagnosis and recommended treatment. The person may decide to seek the medical opinions of one or more second health care providers, including their diagnoses and recommended treatments, i.e., seek out one or more “second opinions.”

However, obtaining second opinions from second health care providers is burdensome. For example, a significant time commitment is associated with scheduling, travelling to, and attending each appointment with each second health care provider. There are also additional expenses associated with each appointment with each second health care provider, such as travel expenses and professional fees. As a result, a person may decide to not seek out a second opinion from one or more second health care providers, thereby accepting the risk of misdiagnosis. Because of the high rate of misdiagnosis and the diversity of recommended treatments among different health care providers, a person's decision to not seek and obtain one or more second medical opinions may be detrimental to the person's health.

Even if a person does decide to seek and obtain one or more second opinions from one or more second health care providers, it often takes a significant amount of time before the person can receive each second opinion. In particular, there is often a time delay associated with scheduling an appointment with each second health care provider. For example, after receiving a medical opinion from a first health care provider, including a diagnosis and recommended treatment, it may be several months before a second health care provider is available for an appointment. For many medical conditions, this time delay may be detrimental to the person's health.

Cancer is one example of a medical condition that may lead to the aforementioned problems. A person suffering from a form of cancer, feeling symptoms commonly associated with cancer, such as fever, fatigue, weight loss, and pain, may seek treatment for those symptoms from a first health care provider. The first health care provider may misdiagnose the person by, for example, diagnosing the person with a different medical condition often associated with the same or similar symptoms, such as the common flu. Accordingly, the first health care provider may recommend a course of treatment that would be inappropriate for a person with cancer. Because of the problems associated with seeking and obtaining second opinions, the person may decide to not seek and obtain one or more second opinions. As a result, the person may go many months, and even years, without a correct diagnosis and appropriate recommended treatment. This may be detrimental to the person and, in particular, may lead to a decrease in the person's health. Even if the person decides to seek and obtain one or more second medical opinions, the person may be burdened with the time and expense associated with obtaining the one or more second opinions, and may be harmed by the delay that occurs before obtaining the correct diagnosis and appropriate recommended treatment.

In other cases, first health care providers may not be competent in a particular health care field to diagnose a person's medical condition, let alone provide a proper diagnosis and recommended treatment. In these cases, the first health care provider may refer the person to one or more second health care providers that are specialists in a particular health care field. The problems with seeking and obtaining second opinions described above apply equally to seeking and obtaining second medical opinions from second health care providers that are specialists. Moreover, in many cases, there still may be high rates of misdiagnosis by second health care providers that are specialists, and the recommended treatments provided by each specialist may vary.

For example, a person suffering from a broken bone, feeling symptoms commonly associated with a broken bone, such as pain and swelling, may seek treatment for those symptoms from a first health care provider that does not specialize in orthopedics. The first health care provider may provide their medical opinion, and, in many cases, may misdiagnose the person. Alternatively, the first health care provider may refer the person to a second health care provider that specializes in orthopedics because the first health care provider may decide that they are not competent to properly diagnose the person's medical condition and recommend treatment. In turn, the second health care provider, though a specialist in orthopedics, may misdiagnose the person by, for example, diagnosing the person with a different medical condition often associated with the same or similar symptoms, such as a joint sprain. Accordingly, the second health care provider, though a specialist in orthopedics, may recommend a course of treatment that would be inappropriate for a person with a broken bone. In each situation, the person is presented with the same problems described above.

Few providers have attempted to overcome the problems described above by utilizing technology to facilitate the receipt of second opinions from one or more second health care providers. Some second health care providers permit a person to upload, over the Internet to the second health care provider, health care records provided by a first health care provider in order for the second health care provider to review and provide a second opinion to the person. However, these systems do not create a third health care record based on at least a portion of a plurality of second health care records, for example, by testing for significant differences among the plurality of second health care records including a plurality of diagnoses and recommended treatments. Accordingly, these systems do not allow a person to efficiently and effectively review a plurality of second opinions in order to properly obtain a correct diagnosis and treatment plan.

Thus, a need exists for more convenient and effective systems and methods for increasing peoples' health and safety and decreasing health care costs by distributing a person's first health care record to a plurality of second health care providers to facilitate the receipt of a plurality of second health care records, such as second opinions, and thereafter creating a third health care record based on at least a portion of the received plurality of second health care records.

### SUMMARY OF THE INVENTION

According to certain inventive techniques, a system for distributing a person's health care records to a plurality of health care providers to facilitate receipt of a plurality of medical opinions includes a communications network, at least one first server communicatively coupled to the communications network, a plurality of second servers communicatively coupled to the communications network, and at least one third server, having a processor coupled to a memory having an application stored thereon, communicatively coupled to the communications network. The at least one first server of the system is capable of storing a first health care record of a first person received from a first health care provider. The plurality of second servers are each capable of storing a second health care record of the first person, wherein at least a portion of each stored second health care record includes health care information supplemental to the first health care record. The application stored on the at least one third server is configured to receive over the communications network at the third server the first health care record of the first person from the at least one first server; transmit the first health care record over the communications network to the plurality of second servers; receive over the communications network at the third server a plurality of second health care records from the plurality of second servers; create a third health care record of the first person based on at least a portion of the plurality of second health care records; and transmit the third health care record over the communications network to at least one of the first health care provider, each second health care provider that transmitted a second health care record, and the first person.

The application stored on the at least one third server may be further configured to cause the third server to receive over the communications network at the third server instructions from the first person identifying the plurality of second servers to which the third server will transmit the first health care record. The application stored on the at least one third server may be further configured to cause the third server to receive over the communications network at the third server instructions from the first person identifying the at least one of the first health care provider, each second health care provider that transmitted a second health care record, and the first person to which the third server will transmit the third health care record. The application stored on the at least one third server may be further configured to cause the third server to query over the communications network the at least one first server for receipt of the first health care record. The application stored on the at least one third server may be further configured to cause the third server to query over the communications network the plurality of second servers for receipt of the plurality of second health care records. The application stored on the at least one third server may be further configured to cause the third server to test for significant differences among the plurality of second health care records, and create the third health care record of the first person based at least in part by the test for significant differences among the plurality of second health care records.

According to certain inventive techniques, a method for distributing a person's health care records to a plurality of health care providers to facilitate the receipt of a plurality of medical opinions includes receiving over a communications network at a server a first health care record of a first person from a first health care provider; causing the server to transmit the first health care record over the communications network to a plurality of second health care providers; receiving over the communications network at the server a plurality of second health care records of the first person received from the plurality of second health care providers, wherein at least a portion of each received second health care record includes health care information supplemental to the first health care record; causing the server to create a third health care record of the first person based on at least a portion of the plurality of second health care records; and causing the server to transmit the third health care record over the communications network to at least one of the first health care provider, each second health care provider that transmitted a second health care record, and the first person.

The method may further include the step of receiving over the communications network at the server instructions from the first person identifying the plurality of second health care providers to which the server will transmit the first health care record. The method may further include the step of receiving over the communications network at the server instructions from the first person identifying the at least one of the first health care provider, each second health care provider that transmitted a second health care record, and the first person to which the server will transmit the third health care record. The method may further include the step of causing the server to query over the communications network the first health care provider for receipt of the first health care record. The method may further include the step of causing the server to query over the communications network the plurality of second health care providers for receipt of the plurality of second health care records. The method may further include the step of causing the server to test for significant differences among the plurality of second health care records, and causing the server to create the third health care record of the first person based at least in part by the test for significant differences among the plurality of second health care records.

According to certain inventive techniques, at least one computer-readable medium includes instructions executable to cause a system to perform operations including receiving over a communications network at a server, the server including a processor coupled to a memory having an application stored thereon, a first health care record of a first person from a first health care provider; causing the server to transmit the first health care record over the communications network to a plurality of second health care providers; receiving over the communications network at the server a plurality of second health care records of the first person received from the plurality of second health care providers, wherein at least a portion of each received second health care record includes health care information supplemental to the first health care record; causing the server to create a third health care record of the first person based on at least a portion of the plurality of second health care records; causing the server to transmit the third health care record over the communications network to at least one of the first health care provider, each second health care provider that transmitted a second health care record, and the first person.

The at least one computer-readable medium may further include instructions executable to cause a system to perform operations including receiving over the communications network at the server instructions from the first person identifying the plurality of second health care providers to which the server will transmit the first health care record. The at least one computer-readable medium may further include instructions executable to cause a system to perform operations including receiving over the communications network at the server instructions from the first person identifying the at least one of the first health care provider, each second health care provider that transmitted a second health care record, and the first person to which the server will transmit the third health care record. The at least one computer-readable medium may further include instructions executable to cause a system to perform operations including causing the server to query over the communications network the first health care provider for receipt of the first health care. The at least one computer-readable medium may further include instructions executable to cause a system to perform operations including causing the server to query over the communications network the plurality of second health care providers for receipt of the plurality of second health care records. The at least one computer-readable medium may further include instructions executable to cause a system to perform operations including causing the server to test for significant differences among the plurality of second health care records, and causing the server to create the third health care record of the first person based at least in part by the test for significant differences among the plurality of second health care records.

### BRIEF DESCRIPTION OF SEVERAL VIEWS OF THE DRAWINGS

FIG. 1 illustrates a networked system, according to techniques of the present application.

FIG. 2 illustrates a first person and the first person's communication device communicatively coupled to the networked system of FIG. 1, according to techniques of the present application.

FIG. 3 illustrates a first or second health care provider, including the first or second health care provider's server, communicatively coupled to the networked system of FIG. 1, according to techniques of the present application.

FIG. 4 illustrates an intermediary server communicatively coupled to the networked system of FIG. 1, according to techniques of the present application.

FIG. 5 illustrates a remote monitoring system communicatively coupled to the networked system of FIG. 1, according to techniques of the present application.

FIG. 6 illustrates the networked system of FIG. 1, further illustrating permission pathways of the first person, according to techniques of the present application.

FIG. 7 illustrates a flow chart for a method for distributing a first person's health care records to a plurality of health care providers to facilitate the receipt of a plurality of medical opinions, according to the techniques of the present application.

FIG. 8 illustrates a third health care record of a first person based on at least a portion of a plurality of medical opinions received over the networked system of FIG. 1, according to the techniques of the present application.

The foregoing summary, as well as the following detailed description of certain techniques of the present invention, will be better understood when read in conjunction with the appended drawings. For the purposes of illustration, certain techniques are shown in the drawings. It should be understood, however, that the claims are not limited to the arrangements and instrumentality shown in the appended drawings.

Furthermore, the appearance shown in the drawings is one of many ornamental appearances that can be employed to achieve the stated functions of the system.

### DETAILED DESCRIPTION OF THE APPLICATION

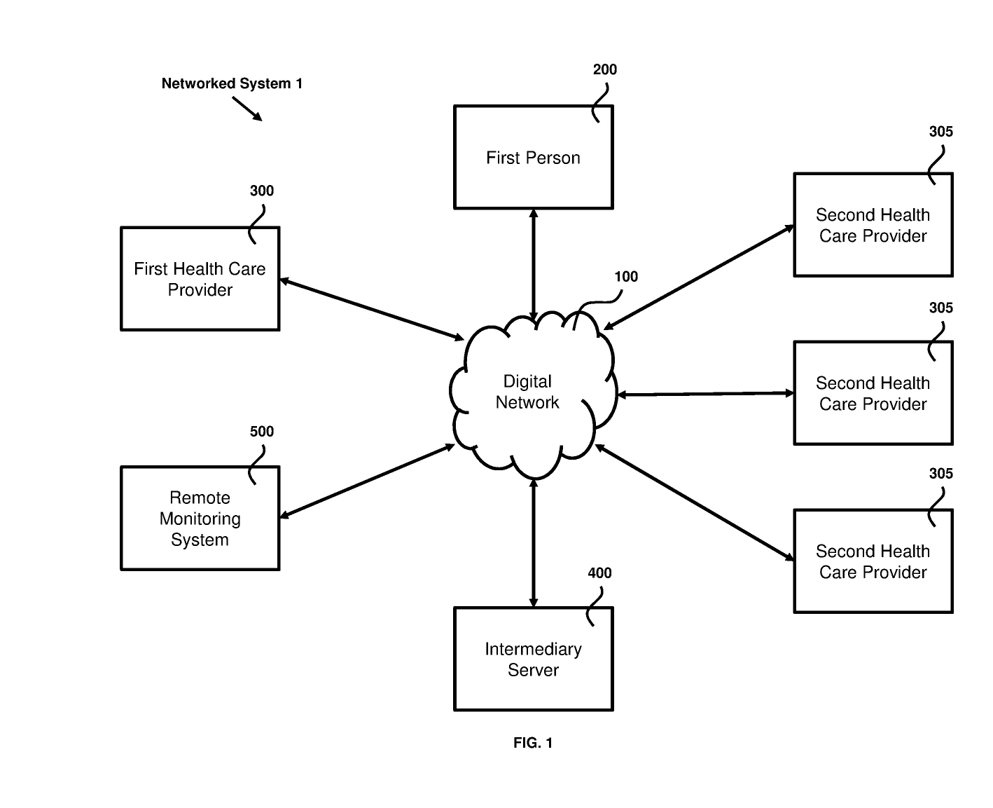

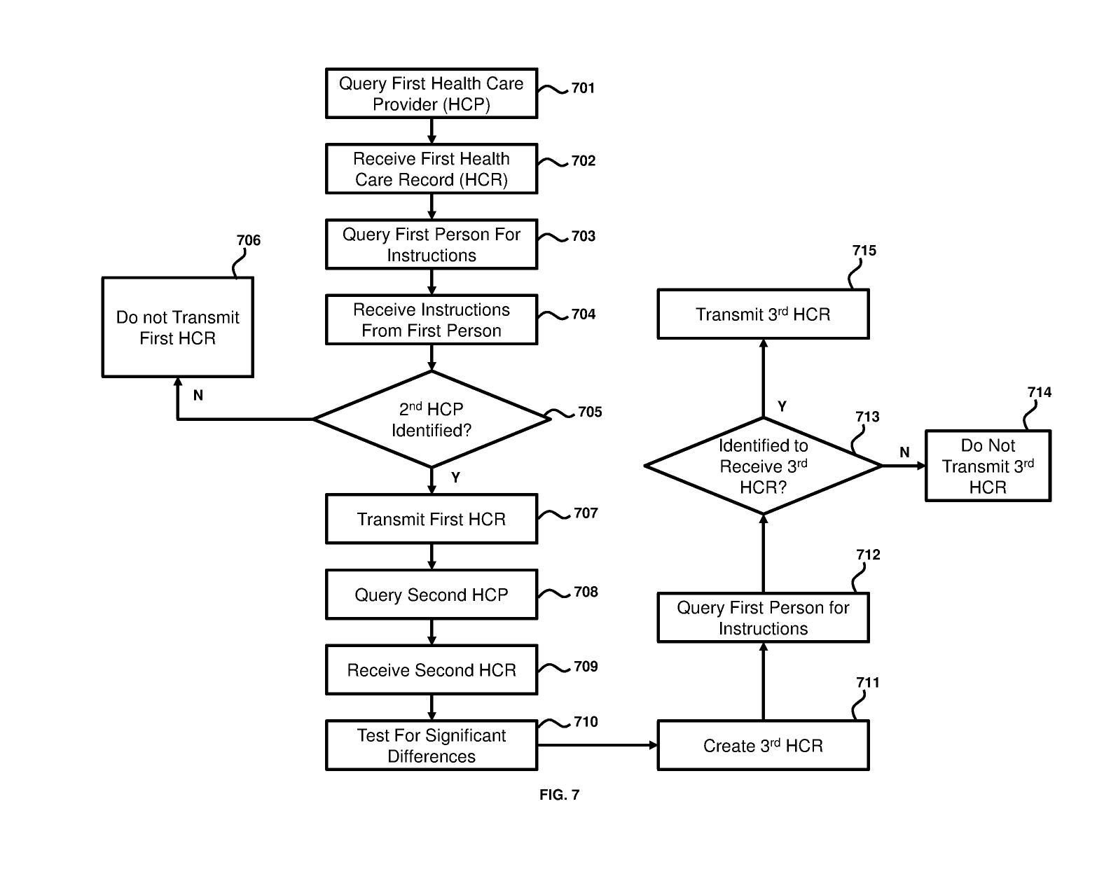

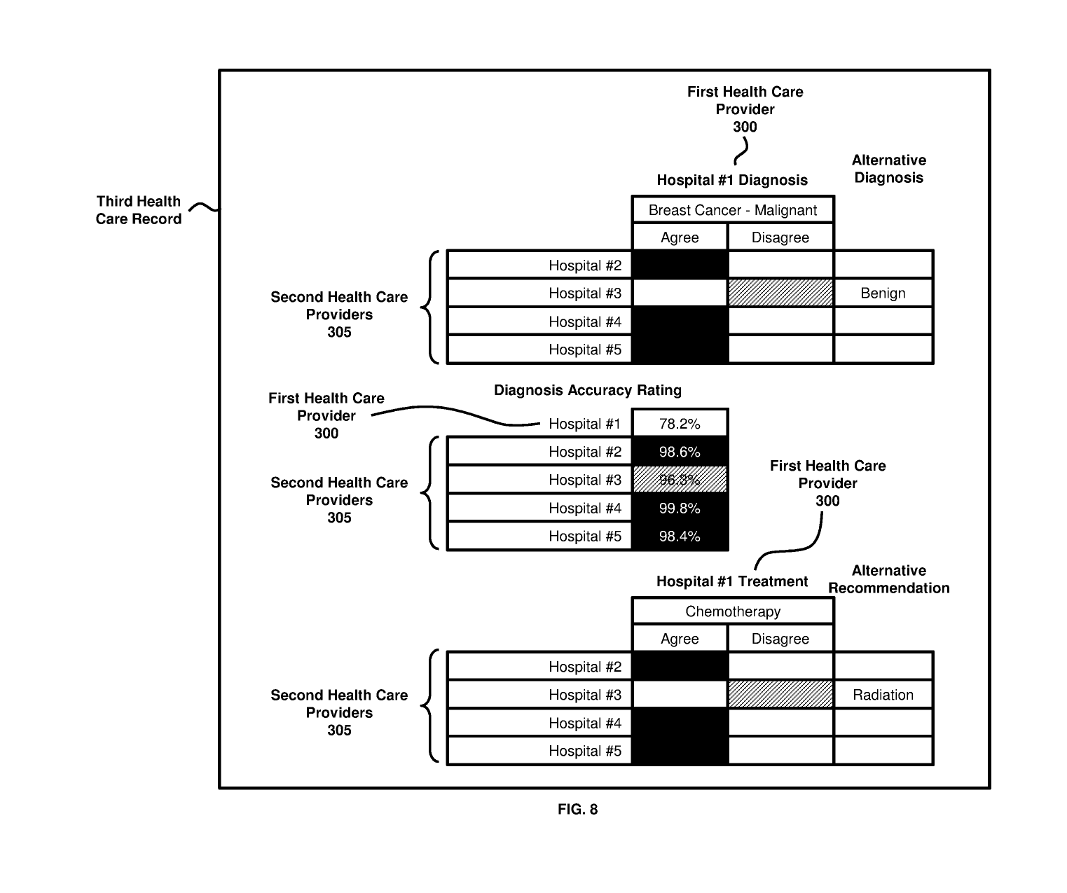

FIGS. 1-6 illustrate various aspects of a networked system 1 for distributing a person's health care records to a plurality of health care providers to facilitate the receipt of a plurality of second medical opinions, thereafter creating a subsequent health care record based on at least a portion of the received plurality of second medical opinions (illustrated by, for example, FIG. 8). FIG. 7 illustrates a flow chart for a method implemented by the networked system 1 of FIGS. 1-6.

FIG. 1 illustrates various aspects of an exemplary architecture implementing the systems and methods described in the present application. In particular, FIG. 1 illustrates a networked system 1 for implementing the techniques described in the present application. Networked system 1 may include a digital network 100. Networked system 1 may further include a first person 200, a first health care provider 300, at least one second health care provider 305, an intermediary server 400, and a remote monitoring system (“RMS”) 500. Each of the first person 200, first health care provider 300, at least one second health care provider 305, intermediary server 400, and RMS 500 may communicate with each other through digital network 100.

Digital network 100 may be a proprietary network, a secure public Internet, a virtual private network, or some other type of network that may communicatively couple each of the first person 200, first health care provider 300, at least one second health care provider 305, intermediary server 400, and RMS 500, such as dedicated access lines, ordinary telephone lines, cellular networks, satellite networks, or a combination of the foregoing. Where the digital network 100 comprises the Internet, data communication may take place over the digital network 100 via an Internet communication protocol.

As illustrated in FIG. 1, digital network 100 is configured to allow data communication among each of the first person 200, first health care provider 300, at least one second health care provider 305, intermediary server 400, and RMS 500. In one embodiment, and as further described below, first person 200 may communicate with first health care provider 300, such as by sending an e-mail over digital network 100 requesting for a first health care record (not illustrated) of first person 200.

A first health care record of first person 200 may include, by way of example: (i) name, address, and contact information; (ii) medical history, including medical history of relatives of first person 200; (iii) medical test results including x-rays, MRI's, blood tests and other lab results, prescription medications; (iv) and diagnoses of health care providers, including first health care provider 300. It should be appreciated that a first health care record of the first person 200 is not limited to the foregoing examples and may include a variety of other data and information.

In one embodiment, and as further described below, a second health care provider 305 may communicate with first health care provider 300 and/or first person 200 by uploading over the Internet a second health care record of first person 200. As described in more detail below, a second health care record (not illustrated) of first person 200 may be received from each of the plurality of second health care providers 305. The second health care record may include the same type of information as described above for the first health care record. Each second health care record may further include data and information supplemental to the first health care record.

By way of example, a second health care record may include a second opinion of one of the plurality of second health care providers 305, which may include a diagnosis and recommended treatment different from the first health care record. Of course, the second health care record may include other supplemental information than a second diagnosis and recommended treatment, such as the results of additional procedures and test results. It should also be appreciated that each second health care record may further include all of the data and information from the first health care record.

In one embodiment, intermediary server 400 may create a third health care record. The third health care record may include the same type of information as described above for the first and second health care records. The third health care record may be based at least on a portion of each of the second health care records received from a plurality of the second health care providers 305. For example, intermediary server 400 may condense the plurality of second health care records received from the plurality of second health care providers 305 by, for example, providing a summary of each of the second health care records in the condensed third health care record. By way of further example, and as described below, intermediary server 400 may test for significant differences among the plurality of second health care records, and in particular, intermediary server 400 may test for significant differences among the diagnoses and recommended treatments included in the plurality of second health care records. Intermediary server 400 may use statistical algorithms such as the Kappa statistic (described below), and modified versions thereof, to test for significant differences among the plurality of second health care records, including among the diagnoses and recommended treatments included in the plurality of second health care records. In this embodiment, after intermediary server 400 has tested for significant differences among the plurality of second health care records, it may create a third health care record describing the results of its test for significant differences, including identifying any diagnoses or recommended treatments that are significantly different than others, and therefore, more likely to be the correct diagnosis and proper recommended treatment for first person 200. The third health care record may identify first health care provider 300 and each of the plurality of second health care providers 305, along with their corresponding diagnoses and recommended treatments. In one embodiment, the third health care record may graphically compare the diagnoses and recommended treatments of first health care provider 300 and each of the plurality of second health care providers 305. The third health care record may further include the diagnosis accuracy of the first health care provider 300 and each of the plurality of second health care providers 305. The third health care record may further include patient satisfaction ratings for the first health care provider 300 and each of the plurality of second health care providers 305. After intermediary server 400 creates the third health care record, including some or all of the information described herein, the third health care record may be transmitted to at least one of the first person 200, first health care provider 300, and/or each of the plurality of second health care providers 305.

FIG. 8 illustrates one embodiment of a third health care record of first person 200. As illustrated in FIG. 8, the third health care record may graphically compare the diagnoses and recommended treatments of first health care provider 300 and each of a plurality of second health care providers 305. In the example illustrated in FIG. 8, first health care provider 300 (“Hospital #1”) diagnosed first person 200 with malignant breast cancer, and recommended treatment of chemotherapy. As illustrated in FIG. 8, the third health care record may graphically compare the diagnosis and recommended treatment of first health care provider 300 with the diagnoses and recommended treatments of a plurality of second health care providers 305 (“Hospital #2,” “Hospital #3,” “Hospital #4,” and “Hospital #5”). In the example illustrated in FIG. 8, three of four second health care providers 305 agreed with the diagnosis and recommended treatment of first health care provider 300, namely “Hospital #2,” “Hospital #4,” and “Hospital #5.” In the example illustrated in FIG. 8, one of four second health care providers 305, “Hospital #3,” disagreed with the diagnosis and recommended treatment of first health care provider 300, and instead diagnosed first person 200 with benign breast cancer, and recommended treatment of radiation. Further, and as illustrated in FIG. 8, the third health care record may include the diagnosis accuracies (measured in % correct diagnoses) of first health care provider 300 (“Hospital #1”) and each of the plurality of second health care providers 305 (“Hospital #2,” “Hospital #3,” “Hospital #4,” and “Hospital #5”). Although not illustrated in FIG. 8, the third health care record may further include patient satisfaction ratings (measured in, for example, stars, e.g., 4.5 out of 5 stars) of the first health care provider 300 and each of the plurality of second health care providers 305.

It should be appreciated that all data and information collected and processed by intermediary server 400 may not be included in the third health care report. For example, as described below, intermediary server 400 may internalize certain data and information, such as diagnosis accuracies and patient satisfaction ratings of first health care provider 300 and each of the plurality of second health care providers 305, for use in its tests for significant differences among the diagnoses and recommended treatments of first health care provider 300 and a plurality of second health care providers 305.

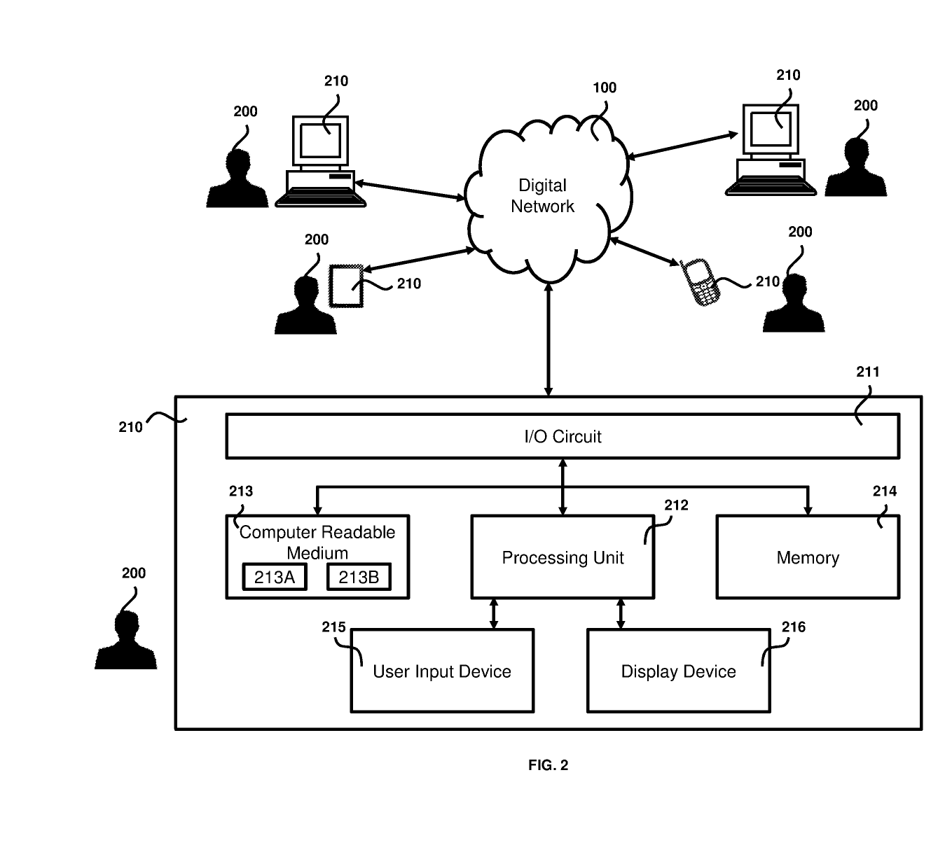

FIG. 2 illustrates first person 200 having a communication device 210. As illustrated in FIGS. 1 and 2, first person 200 and their communication device 210 are communicatively coupled to first health care provider 300, at least one second health care provider 305, intermediary server 400, and RMS 500 via digital network 100.

First person 200 may include, for example, a patient, relative of a patient, guardian or conservator of a patient, etc. As illustrated in FIG. 2, the communication device 210 of first person 200 may be a desktop computer, laptop computer, web-enabled mobile device, such as an iPhone® or iPad®, cellular telephone, or other devices capable of communicatively coupling to digital network 100.

The communication device 210 of first person 200 may include an input/output circuit 211 (“IO circuit”), processing unit 212, computer readable medium 213, memory 214, user input device 215, and display device 216.

IO circuit 211 may operatively connect processing unit 212, computer readable medium 213, memory 214, user input device 215, and display device 216 to digital network 100 to perform the various functions described herein. Although FIG. 2 illustrates the IO circuit 211 as a single IO circuit, it should be appreciated that IO circuit 211 may include multiple IO circuits. Moreover, although FIG. 2 illustrates the IO circuit 211 as a single block, it should be appreciated that IO circuit 211 may include a number of different types of IO circuits.

IO circuit 211 may be in communication with a processing unit 212. Processing unit 212 may be adapted and configured to execute various software applications and components of networked system 1 including, for example, software applications including software instructions to implement the method depicted in FIG. 7. Processing unit 212 may include multiple processing units.

IO circuit 211 and processing unit 212 may be in communication with one or more computer readable media 213. Computer readable medium 213 may include software applications 213A and 213B, which, for example, may provide software instructions to be executed by processing unit 212. It should be appreciated that computer readable medium 213 may include more or less software applications than 213A and 213B, yet remain configured to sufficiently provide instructions necessary for networked system 1 to perform the functions described herein.

In one embodiment, software application 213A may allow communication device 210 to perform various tasks associated with the operation of communication devices. While software application 213A is depicted in FIG. 2 as a single module, software application 213A may include any number of modules accomplishing tasks related to communication device operations, including, for example, making and accepting telephone calls, sending and receiving email and text messages, etc.

In another embodiment, software application 213B may be a user interface application for allowing first person 200, by use of communication device 210, to input and view data associated with networked system 1, and to interact with networked system 1 including first health care provider 300, each of the plurality of second health care providers 305, intermediary server 400, and RMS 500.

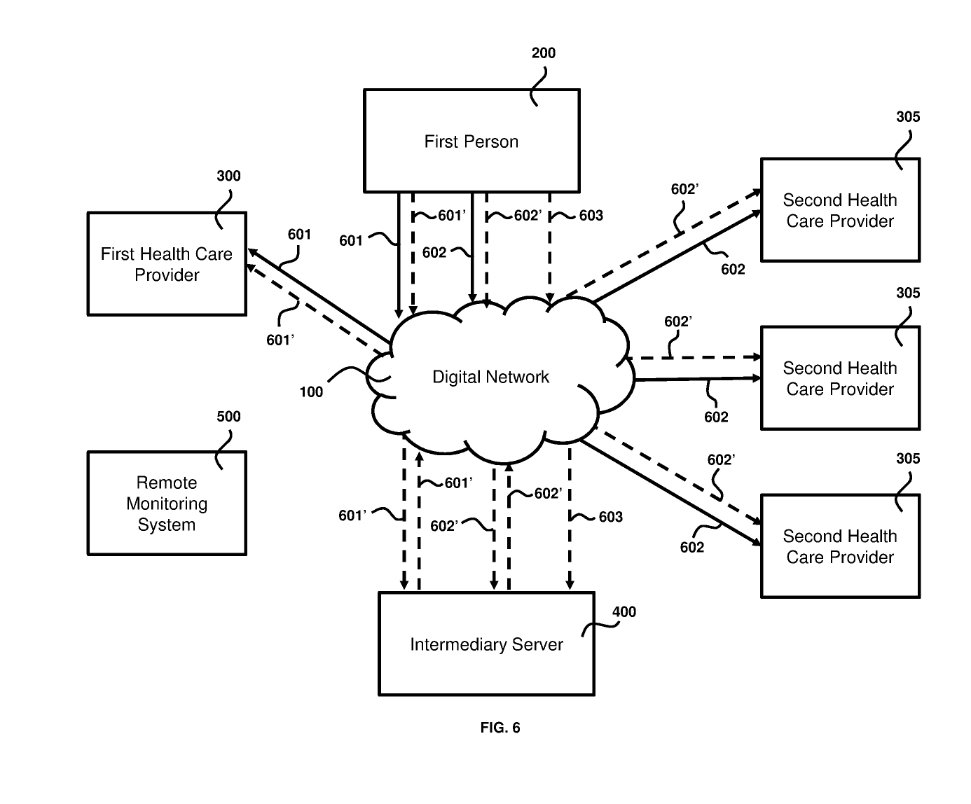

For example, as illustrated in FIGS. 6 and 7 and described below, software application 213B may allow the first person 200 to provide instructions to first health care provider 300, each of the plurality of the second health care providers 305, and intermediary server 400. The instructions provided by first person 200 may identify the plurality of second health care providers 305 which will receive a first health care record of the first person 200. The instructions may further identify the first person 200, first health care provider 300, or intermediary server 400 which will receive a second health care record. The instructions may further identify which of the first health care provider 300, each of the plurality of second health care providers 305, and first person 200 should receive a third health care record based on at least a portion of a plurality of second health care records received from a plurality of the second health care providers 305.

FIG. 6 illustrates the transmission of instructions (illustrated as instructions 601 and 601′, 602 and 602′, and 603) from first person 200 over digital network 100. As illustrated in FIG. 6, first person 200 may provide instructions 601 via network 100 directly to first health care provider 300. Alternatively, first person 200 may provide instructions 601′ (illustrated in dashed lines) indirectly to first health care provider by first transmitting, via network 100, instructions to intermediary server 400, which then forwards, via digital network 100, the same instructions 601′. Alternatively, first person 200 may provide instructions 601′ directly to intermediary server 400 without further transmission to first health care provider 300. Instructions 601 and 601′ may each include the identity of each of the plurality of second health providers 305 to which intermediary server 400 will transmit a first health care record of the first person 200. In this regard, by facilitating the transmission and receipt of instructions 601 and 601′, networked system 1 allows first person 200 to give permission as to which parties, if any, including second health care providers 305, shall receive the first health care record of the first person 200.

As further illustrated in FIG. 6, first person 200 may transmit instructions 602 and 602′ over digital network 100 to a plurality of second health care providers 305. First person 200 may provide instructions 602 directly to one or more second health care providers 305 via network 100. Alternatively, first person 200 may transmit instructions 602′ (illustrated by dashed lines) indirectly to the plurality of second health care providers 305 by first transmitting via network 100, instructions to intermediary server 400, which then forwards, also via network 100, the same instructions 602′ to the plurality of second health care providers 305. Alternatively, first person 200 may transmit instructions 602′ to intermediary server 400 without further transmission to the plurality of second health care providers 305. Instructions 602 and 602′ may each include the identity of the first person 200, first health care provider 300, and intermediary server 400 which will receive a second health care record. In this regard, by facilitating the transmission and receipt of instructions 602 and 602′, networked system 1 allows first person 200 to give permission as to which parties, if any, including first person 200 and first health care provider 305, shall receive the plurality of second health care records of first person 200.

As further illustrated in FIG. 6, first person 200 may transmit instructions 603 (illustrated by dashed lines) over digital network 100 to intermediary server 400. Instructions 603 may include the identity of the first person 200, first health care provider 300, and each of the plurality of second health care providers 305 to which the intermediary server 400 will transmit a third health care record. In this regard, by facilitating the transmission and receipt of instructions 603, networked system 1 allows the first person 200 to give permission to intermediary server 400 as to which parties, if any, including first person 200, first health care provider 300, and each of the plurality of second health care providers 305, shall receive the third health care record.

Although FIG. 6 illustrates only three instructions (601 and 601′, 602 and 602′, and 603) sent over digital network 100 by first person 200, it should be appreciated that first person 200 may send more or fewer instructions without detracting from the scope of the invention described herein.

In one embodiment, user interface application 213B is a web browser client. However, it should be appreciated that interface application 213B may be any type of interface application, including a proprietary interface application, and may communicate with networked system 1 using any type of protocol including, but not limited to, file transfer protocol (FTP), telnet, hypertext-transfer protocol (HTTP), hypertext-transfer protocol secure (HTTPS), etc. While software application 213B is depicted in FIG. 2 as a single module, software application 213B may include any number of modules accomplishing the foregoing described tasks.

IO circuit 211, processing unit 212, and computer readable medium 213 may be in communication with a memory 214. Although FIG. 2 illustrates a single memory 214, it should be appreciated that communication device 210 of first person 200 may include multiple memories 214. These memories may be used for storage and retrieval of information and data associated with software applications 213A and 213B of computer readable medium 213.

IO circuit 211, processing unit 212, computer readable medium 213, and memory 214 may be in communication with a user input device 215 to perform the operations described herein. Although FIG. 2 illustrates a single user input device 215, it should be appreciated that user input device 215 may include multiple user input devices 215. Although not illustrated in FIG. 2, user input device 215 may include a mousing device, voice control device, camera, or any other user input device capable of performing the functions described herein. First person 200 may be able to interact with software applications 213A and 213B stored on computer readable medium 213 through user input device 215 to perform interactions described herein. An interaction may include a mouse movement, mouse click, mouse hover, keyboard input, touch interaction (for example, pinching or touching to zoom in or out), eye movements, body movements, mouse gestures, touch gestures, or the like.

In response to a user interaction, the processing unit 212 may receive an interaction signal. For example, if a user clicks on or hovers an icon with a mouse, this may cause the processing unit 212 to receive an icon interaction signal. As another example, if a user clicks on a hyperlink or shortcut, this may cause the processing unit 212 to receive a navigation signal. These are just a few examples. Any type of interaction with the applications 213A and 213B may result in a corresponding signal that is received by the processing unit 212.

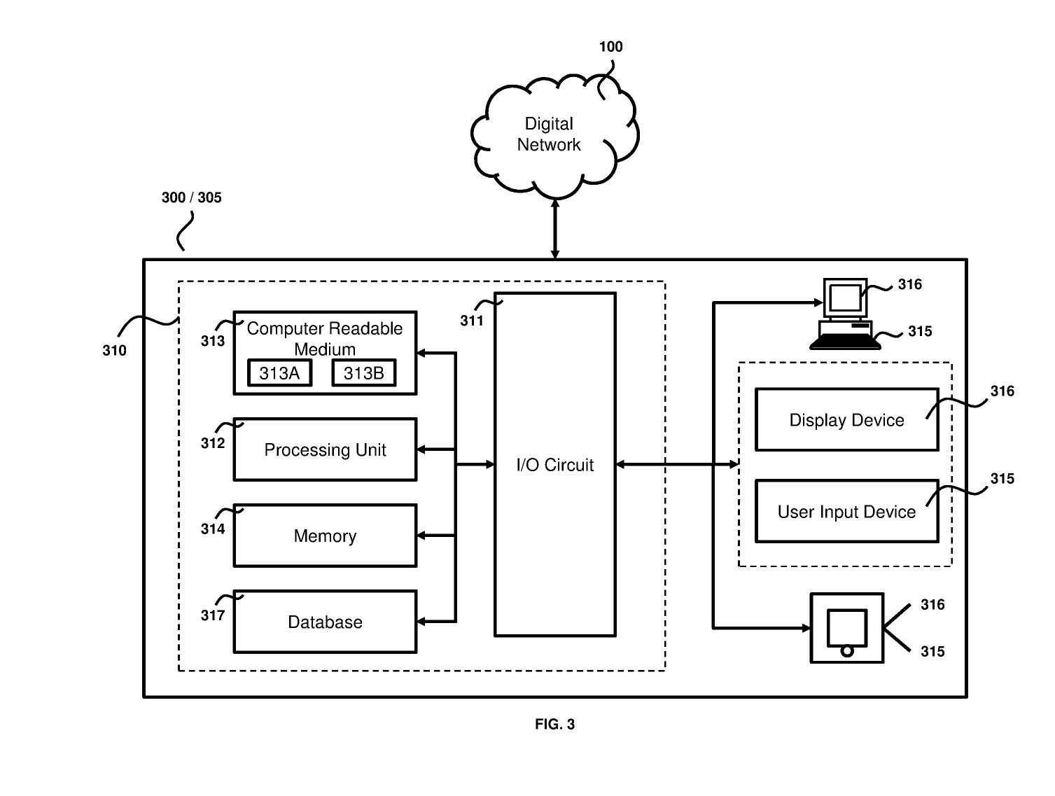

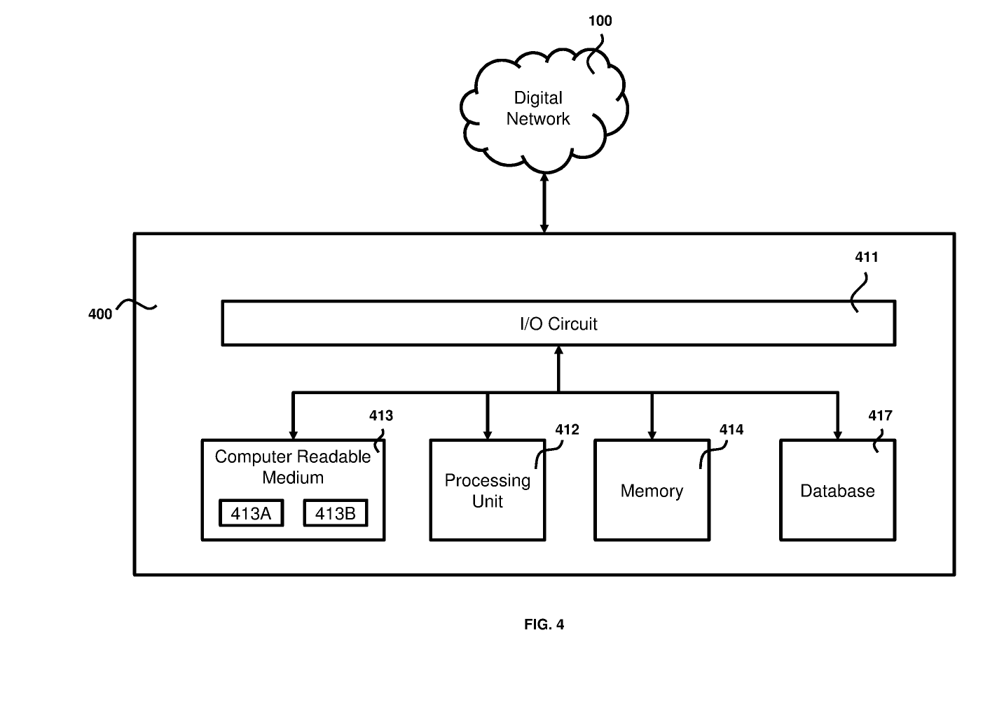

Processing unit 212 may generate data, such as data used in software applications 213A and/or 213B or, for example, in the method illustrated in FIG. 7. Processing unit 212 may transmit such data to a display device 216, which may also be in communication with 10 circuit 211, processing unit 212, computer readable medium 213, memory 214, and user input device 215 to perform the operations described herein. Although FIG. 2 illustrates only one display device 216, it should be appreciated that display device 216 may include multiple display devices 216. As illustrated in FIG. 2, and by way of example, display device 216 may include a desktop computer monitor, laptop computer monitor, screen of a web-enabled mobile device, such as an iPhone® or iPad® screen, screen of a cellular telephone, or other display devices capable of communicatively coupling to digital network 100. As described further below, display device 216 may display to first person 200 data inputted by first person 200 by user input device 215, data received over digital network 100 such as a first health care record of first person 200 received from first health care provider 300 (illustrated in FIG. 3), a plurality of second health care records received from a plurality of second health care providers 305 (illustrated in FIG. 3), or a third health care record created by and received from intermediary server 400 (illustrated in FIG. 4). For example, display device 216 may display to first person 200 a third health care record (illustrated in FIG. 8), which may identify and graphically compare the diagnoses and recommended treatments of first health care provider 300 and each of the plurality of second health care providers 305, and further display diagnosis accuracies and patient satisfaction ratings of first health care provider 300 and each of the second health care providers 305.

Although not illustrated in FIG. 2, the communication device 210 of first person 200 may further include a database similar to database 317 (illustrated in FIG. 3) in communication with other components of communication device 210. A database associated with communication device 210 of first person 200 may allow for storage on communication device 210 of data and information including, among other things, health care records of first person 200, including a first health care record received from first health care provider 300, a plurality of second health care records received from a plurality of second health care providers 305, and a third health care record based on at least a portion of the plurality of second health care records.

FIG. 3 illustrates first health care provider 300 and each of the plurality of second health care providers 305. First health care provider 300 and each of the second health care providers 305 may have separate systems, with varying architectures, for performing the methods and functions described herein. However, the systems of the first health care provider 300 and each of the second health care providers 305 may be the same. Accordingly, the present application describes the systems associated with first health provider 300 and each of the plurality of second health care providers 305 together with reference to the systems of the first health care provider 300. The following description further applies to the systems associated with each of the plurality of second health care providers 305.

As illustrated in FIGS. 1 and 3, first health care provider 300 may have system architecture that is communicatively coupled to first person 200, each of the plurality of second health care providers 305, intermediary server 400, and RMS 500 via digital network 100.

First health care provider 300 may have system architecture that includes a first health care provider server 310 including an IO circuit 311, processing unit 312, computer readable medium 313, memory 314, and database 317, wherein each component is in communication with the others. The first health care provider server 310 may be operatively connected to a user input device 315 and display device 316. In another embodiment, the system architecture of the first health care provider 300 does not include a first health care server 310. In each embodiment, IO circuit 311, processing unit 312, computer readable medium 313, memory 314, user input device 315, display device 316, and database 317 are communicatively coupled to each other and to digital network 100.

IO circuit 311 may operatively connect processing unit 312, computer readable medium 313, memory 314, user input device 315, display device 316, and database 317 to digital network 100 to perform various functions described herein. Although FIG. 2 illustrates IO circuit 311 as a single IO circuit, it should be appreciated that IO circuit 311 may include multiple IO circuits. Moreover, although FIG. 3 illustrates IO circuit 311 as a single block, it should be appreciated that IO circuit 311 may include a number of different types of IO circuits.

IO circuit 311 may be in communication with processing unit 312. Processing unit 312 may be adapted and configured to execute various software applications and components of networked system 1 including, for example, software applications including software instructions to implement the method depicted in FIG. 7. For example, processing unit 312 may be adapted and configured to execute software applications 313A and 313B, for example and as described below, receive a query from intermediary server 400, and transmit a first health care record of first person 200. Processing unit 312 may include multiple processing units.

IO circuit 311 and processing unit 312 may be in communication with computer readable medium 313. Although FIG. 3 illustrates computer readable medium 313 as a single computer readable medium, it should be appreciated that computer readable medium 313 may include multiple computer readable media. Computer readable medium 313 may include software applications 313A and 313B, which, for example, may provide software instructions for execution by processing unit 312. It should be appreciated that computer readable medium 313 may include more or less software applications than 313A and 313B yet still be configured to provide instructions necessary for the system to perform the functions described herein.

In one embodiment, software application 313A may allow first health care provider 300, including first health care provider server 310, to perform various tasks associated with the operations of health care providers. While software application 313A is depicted in FIG. 3 as a single module, software application 313A may include any number of modules accomplishing tasks related to the operations of health care providers, including, for example, scheduling appointments, inputting medical information into a patient's medical record, performing medical procedures, analyzing results of medical tests, etc.

In another embodiment, software application 313B may be an interface application for allowing the first health care provider 300, for example, by use of user input device 315 and display device 316, to input and view data associated with networked system 1, and to interact with networked system 1 including first person 200, each of the plurality of second health care providers 305, intermediary server 400, and RMS 500.

For example, as illustrated in FIG. 7 and described below, software application 313B may allow the first health care provider 300 to receive a query from intermediary server 400. The query from intermediary server 400 may be for the receipt of a first health care record of first person 200. By way of further example, as illustrated in FIG. 7 and described below, software application 313B may also allow first health care provider 300 to transmit the first health care record to each of the plurality of second health care providers 305. By way of further example, as illustrated in FIG. 7 and described below, software application 313B may also allow first health care provider 300 to receive a plurality of second health care records. By way of further example, as illustrated in FIG. 7 and described below, software application 313B may also allow first health care provider 300 to receive a third health care record based at least on a portion of a plurality of second health care records including second opinions, received from a plurality of second health care providers 305.

In one embodiment, user interface application 313B is a web browser client. However, it should be appreciated that interface application 313B may be any type of interface application, including a proprietary interface, and may communicate with networked system 1 using any type of protocol including, but not limited to, file transfer protocol (FTP), telnet, hypertext-transfer protocol (HTTP), hypertext-transfer protocol secure (HTTPS), etc. While software application 313B is depicted in FIG. 3 as a single module, the software application 313B may include any number of modules accomplishing the foregoing described tasks.

IO circuit 311, processing unit 312, and computer readable medium 313 may be in communication with a memory 314. Although FIG. 3 illustrates a single memory 314, it should be appreciated that memory 314 may include multiple memories 314. Memory 314 may be used for storage and retrieval of information and data associated with software applications 313A and 313B of computer readable medium 313.

IO circuit 311, processing unit 312, computer readable medium 313, and memory 314 may be in communication with a user input device 315 to perform the operations described herein. User input device 315 may include a mousing device, voice control device, camera, or any other user input device capable of performing the functions described herein. User input device 315 may include multiple user input devices 315. First health care provider 300 may interact with software applications 313A and 313B stored on computer readable medium 313 through the user input device 315 to perform functions described herein. An interaction may include a mouse movement, mouse click, mouse hover, keyboard input, touch interaction (for example, pinching or touching to zoom in or out), eye movements, body movements, mouse gestures, touch gestures, or the like. In response to a user interaction, processing unit 312 may receive an interaction signal as described above.

Processing unit 312 may generate data, such as data used in software applications 313A and/or 313B, for example, in the method illustrated in FIG. 7. Processing unit 312 may transmit such data to a display device 316, which may also be in communication with IO circuit 311, processing unit 312, computer readable medium 313, memory 314, and user input device 315 to perform the operations described herein. Although FIG. 3 illustrates only one display device, it should be appreciated that display device 316 may include multiple display devices 316. As illustrated in FIG. 3, and by way of example, display device 316 may include a desktop computer monitor. As described above with reference to display device 216 associated with first person 200, other display devices capable of communicatively coupling to digital network 100 may be used. As described further below, display device 316 may display to first health care provider 300 information related to a query received from intermediary server 400 (illustrated in FIG. 4), instructions received from first person 200 or from intermediary server 400, or a third health care record created by and received from intermediary server 400.

As illustrated in FIG. 3, IO circuit 311, processing unit 312, computer readable medium 313, memory 314, user input device 315, and display device 316 may be in communication with a database 317.

Database 317 may allow for storage of data and information, including, among other things, health care records of first person 200, including a first health care record, a plurality of second health care records received from a plurality of second health care providers 305, and a third health care record based on at least a portion of the plurality of second health care records. Database 317 may be any type of data storage mechanism, e.g., one or more hard disk drives, optical storage drives, solid state storage devices, etc. Database 317 may further allow for storage of data and information related to the normal operations of first health care provider 300, including, among other things, scheduling, employee, and patient data and information not part of a first, second, or third health care record of first person 200. Although FIG. 3 illustrates only one database, it should be appreciated that database 317 may include multiple databases for performing the functions described herein.

FIG. 4 illustrates intermediary server 400. As illustrated in FIGS. 1 and 4, intermediary server 400 may be communicatively coupled to the first person 200 (via communication device 210 of first person 200), first health care provider 300, each of the plurality of second health care providers 305, and RMS 500 via digital network 100. Intermediary server 400 may be a proprietary server, a cloud based server, or some other type of server that may be configured to communicate via digital network 100. Although FIGS. 1 and 4 illustrate a single intermediary server 400, it should be appreciated that multiple intermediary servers 400 may be provided for the purpose of distributing server load, serving a plurality of first, second, and third care records of persons 200, etc.

Intermediary server 400 may have system architecture that includes an IO circuit 411, processing unit 412, computer readable medium 413, memory 414, and database 417. Intermediary server 400 may be configured similarly to the first health care provider server 310 as described above. In another embodiment not illustrated in FIG. 4, intermediary server 400 may further include a user input device 415 and display device 416, which may be configured similarly to user input device 315 and display device 316 described above with reference to FIG. 3.

IO circuit 411 may operatively connect processing unit 412, computer readable medium 413, memory 414, and database 417 to digital network 100 to perform various functions described herein. Although FIG. 4 illustrates IO circuit 411 as a single 10 circuit, it should be appreciated that IO circuit 411 may include multiple IO circuits. Moreover, although FIG. 4 illustrates IO circuit 411 as a single block, it should be appreciated that IO circuit 411 may include a number of different types of IO circuits.

IO circuit 411 may be in communication with processing unit 412. Processing unit 412 may be adapted and configured to execute various software applications and components of networked system 1, including, for example, software applications to implement the method depicted in FIG. 7. For example, processing unit 412 may be adapted and configured to execute software applications 413A and 413B, for example, as described more fully below to: (i) query over digital network 100 first health care provider 300 for receipt of a first health care record of first person 200; (ii) receive over digital network 100 the first health care record of first person 200 from first health care provider 300; (iii) receive over digital network 100 instructions from first person 200 identifying a plurality of second health care providers 305 to which to transmit the first health care record; (iv) transmit the first health care record over digital network 100 to the plurality of second health care providers 305; (v) query the plurality of second health care providers 305 for receipt of a plurality of second health care records; (vi) test for significant differences among the plurality of second health care records; (vii) create a third health care record of first person 200 based on at least a portion of the plurality of second health care records; (viii) receive instructions from first person 200 identifying at least one of the first health care provider 300, each of the plurality of second health care providers 305 that transmitted a second health care record, and first person 200 to which to transmit the third health care record; (ix) transmit the third health care record over digital network 100 to at least one of the first health care provider 300, each of the plurality of second health care providers 305 that transmitted a second health care record, and first person 200. It should be appreciated that processing unit 412 may be adapted and configured to implement other operations of networked system 1, for example, receiving, calculating, and storing data and information corresponding to diagnosis accuracies and patient satisfaction ratings of first health care provider 300 and each of the plurality of second health care providers 305. It should be further appreciated that processing unit 412 may be adapted and configured to implement all of the functions described in the present application, including all of the steps of the method described in FIG. 7. Although FIG. 4 illustrates a single processing unit 412, it should be appreciated that processing unit 412 may include multiple processing units 412.

IO circuit 411 and processing unit 412 may be in communication with computer readable medium 413. Although FIG. 4 illustrates computer readable medium 413 as a single computer readable medium 413, it should be appreciated that computer readable medium 413 may include multiple computer readable media 413. Computer readable medium 413 may include software applications 413A and 413B, which, for example, may provide instructions for execution by processing unit 412 as described above. It should be appreciated that computer readable medium 413 may include more or less software applications than 413A and 413B yet still be configured to provide instructions necessary for networked system 1 to perform the functions described herein.

In one embodiment, software application 413A may allow intermediary server 400 to perform tasks associated with an intermediary server. While software application 413A is depicted in FIG. 4 as a single module, software application 413A may include any number of modules accomplishing tasks related to the operations of an intermediary server, including for example, implementing security measures (described below); completing and logging tasks of networked server 1; logging technical issues of networked server 1, logging correspondence read receipts, e.g., correspondence read receipts received from first health care provider 300 and each of the plurality of second health care providers 305; logging download and upload confirmations; logging response time of first health care provider 300 and each of the plurality of second health care providers 305. In this regard, software application 413A may be adapted and configured to allow intermediary server 400 to perform some or all of the tasks monitored by RMS 500 (described below). In one embodiment, software application 413A may provide for a user interface to intermediary server 400. By way of example, software application 413A may provide a user interface to intermediary server 400, which user interface may, for example, allow an administrator of networked system 1 to configure, troubleshoot, or test various aspects of intermediary server 400's operation, or otherwise to access information on intermediary server 400. In this regard, software application 413A may provide an interface to RMS 500 to allow RMS 500 to remotely monitor networked system 1, including intermediary server 400. Like the software applications described above, although software application 413A is depicted in FIG. 4 as a single module, software application 413A may include any number of modules accomplishing tasks related to the operations of a server.

In another embodiment, software application 413B may be a server application for performing the operations and functions of the intermediary server 400. For example, server application 413B may provide instructions to allow intermediary server 400, through, for example, the use of processing unit 412, to receive, transmit, and forward information over digital network 100 to or from first person 200, first health care provider 300, each of the plurality of second health care providers 305, and RMS 500.

For example, as illustrated in FIG. 7 and described below, server application 413B may allow intermediary server 400 to query over digital network 100 first health care provider 300 for receipt of a first health care record of first person 200. By way of further example, as illustrated in FIG. 7 and described below, server application 413B may allow intermediary server 400 to receive over digital network 100 a first health care record of first person 200. By way of further example, as illustrated in FIG. 7 and described below, server application 413B may allow intermediary server 400 to receive over digital network 100 instructions from first person 200 identifying a plurality of second health care providers 305 to which to transmit the first health care record. By way of further example, as illustrated in FIG. 7 and described below, server application 413B may allow intermediary server 400 to transmit the first health care record over digital network 100 to the plurality of second health care providers 305. By way of further example, as illustrated in FIG. 7 and described below, server application 413B may allow intermediary server 400 to query the plurality of second health care providers 305 for receipt of a plurality of second health care records. By way of further example, as illustrated in FIG. 7 and described below, server application 413B may allow intermediary server 400 to test for significant differences among the plurality of second health care records. By way of further example, as illustrated in FIG. 7 and described below, server application 413B may allow intermediary server 400 to create a third health care record of first person 200 based on at least a portion of the plurality of second health care records. By way of further example, as illustrated in FIG. 7 and described below, server application 413B may allow intermediary server 400 to receive instructions from first person 200 identifying at least one of first health care provider 300, each of the plurality of second health care providers 305 that transmitted a second health care record, and first person 200 to which to transmit the third health care record. By way of further example, as illustrated in FIG. 7 and described below, server application 413B may allow intermediary server 400 to transmit the third health care record over digital network 100 to at least one of first health care provider 300, each of the plurality of second health care providers 305 that transmitted a second health care record, and first person 200.

Although not illustrated in FIG. 7, server application 413B may further allow intermediary server 400 to receive, calculate, and store data and information corresponding to diagnosis accuracies of first health care provider 300 and each of the second health care providers 305. Although not illustrated in FIG. 7, server application 413B may further allow intermediary server 400 to receive, calculate, and store data and information corresponding to patient satisfaction ratings of first health care provider 300 and each of the plurality of second health care providers 305.

As described above, server application 413B may allow intermediary server 400 to test for significant differences among second health care records received from a plurality of second health care providers 305. In one embodiment, server application 413B may provide instructions to intermediary server 400, including processor 412, to use statistical algorithms such as the Kappa statistic, and modified versions thereof, to test for significant differences among the second health care records. The Kappa statistic is a statistical algorithm that measures agreement (beyond agreement due to chance) relative to the maximum possible agreement (beyond agreement due to chance) when working with a categorical outcome, which, in this case, may be used to measure agreement between the diagnoses and recommended treatments of first health care provider 300 and each of the plurality of second health care providers 305. Of course, server application 413B may provide instructions to use modified versions of the Kappa statistic, such as a weighted Kappa statistic, wherein the weights given to the diagnoses and recommended treatments of health care provider 300 and/or a particular health care provider 305 may vary. It should be appreciated that server application 413B may account for time-varying changes in the Kappa statistic, and modified versions thereof, as intermediary server 400 collects data and information from the operation of networked system 1. For example, in allowing intermediary server 400 to test for significant differences among a plurality of second health care records, server application 413B may account for time-changing diagnosis accuracies and/or time-changing patient satisfaction ratings of first health care provider 300 and each of the plurality of second health care providers 305 by modifying a weighted Kappa statistic based on the corresponding time-changing diagnosis accuracies and time-changing patient satisfaction ratings. Of course, it should be appreciated that server application 413B may provide instructions to intermediary server 400, including processor 412, to use statistical algorithms other than the Kappa statistic to test for significant differences among the plurality of second health care records. While the software application 413B is depicted in FIG. 4 as a single module, the software application 413B may include any number of modules accomplishing the foregoing described tasks.

As illustrated in FIG. 4, IO circuit 411, processing unit 412, and computer readable medium 413 may be in communication with a memory 414. Although FIG. 4 illustrates a single memory 414, it should be understood that intermediary server 400 may include multiple memories 414. These memories 414 may be used for storage and retrieval of information and data associated with software applications 413A and 413B of computer readable medium 413.

As illustrated in FIG. 4, IO circuit 411, processing unit 412, computer readable medium 413, and memory 414 may be in communication with a database 417. As described above with regard to database 317, it should be appreciated that database 417 may be any type of data storage medium or mechanism, e.g., one or more hard disk drives, optical storage drives, solid state storage devices, etc. Database 417 may allow for storage of data and information related to the normal operations of intermediary server 400, including, among other things, storing a plurality of first, second, and third health care records. Although FIG. 4 illustrates only one database 417, it should be appreciated that database 417 may include multiple databases 417 for performing the functions described herein.

As illustrated in FIGS. 1-4, the use of intermediary server 400 allows the data processing and storage of networked system 1 to occur off-site relative to first person 200, first health care provider 300, and each of the plurality of second health care providers 305. In this regard, intermediary server 400 improves the functioning of networked system 1 by accepting most, if not all, of the data processing and storage load. Accordingly, intermediary server 400 permits first user 200, first health care provider 300, and each of the plurality of second health care providers 305, to process less data and retain storage space, thereby increasing speed and efficiency.

Moreover, the use of intermediary server 400 within networked system 1 allows for increased security of medical information, including information contained in the first, second, and third health care records of first person 200. In particular, because intermediary server 400 may be configured to perform most, if not all, functions of networked system 1, there is a decrease in the need for security measures because necessary security measures may be focused on one component of networked system 1. Security measures may include, for example, randomized audit checks of intermediary server 400, automatic log-off capabilities of users accessing intermediary server 400, data encryption for all data sent by intermediary server 400, and multi-factor authentication for all users of intermediary server 400, including first person 200, first health care provider 300, and each of the plurality of second health care providers 305. Of course, it should be appreciated that networked system 1, including intermediary server 400, may implement a number of other security measures for the protection of private and sensitive information contained in health care records without detracting from the scope of the present invention. In contrast, without the use of intermediary server 400 within networked system 1, these security measures would need to be implemented at each component of networked system 1, thereby increasing the number of security measures needed, and further increasing the risk that a security measure is breached. Accordingly, the use of intermediary server 400 provides significant security advantages necessary to protect private and sensitive information contained in health care records.

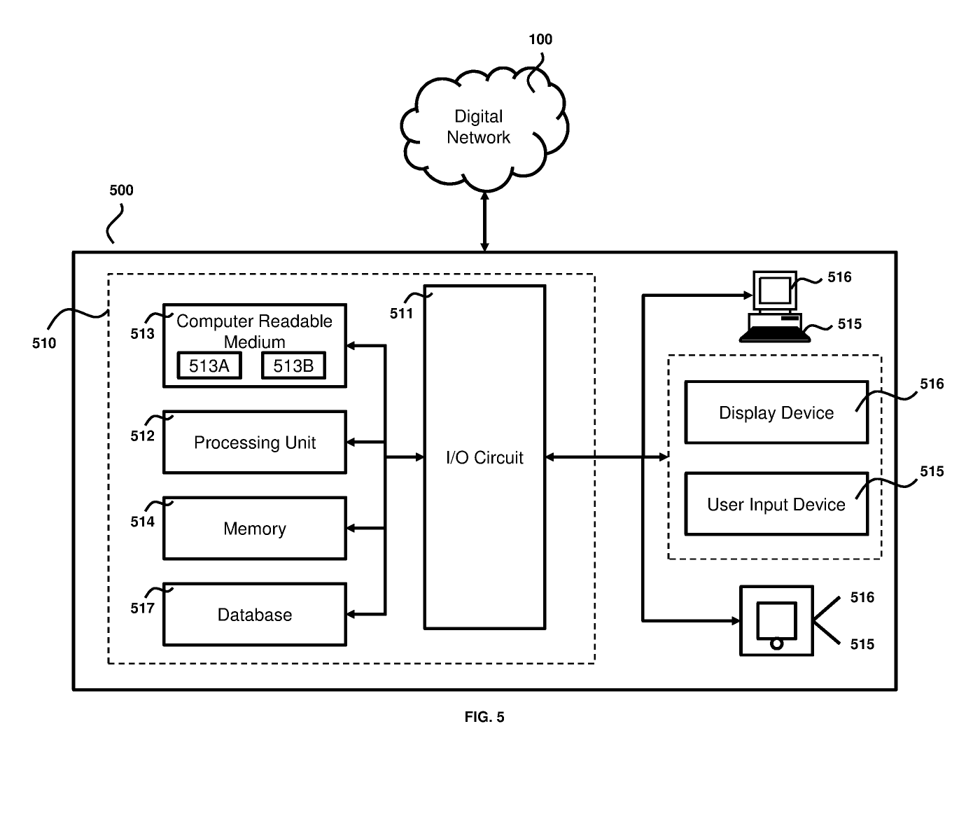

FIG. 5 illustrates remote monitoring system (“RMS”) 500. As illustrated in FIG. 5, the system architecture of RMS 500 may be similar to the system architecture of first health care provider 300 and each of the plurality of second health care providers 305, illustrated in FIG. 3 and described above. In particular, like the system architecture illustrated in FIG. 3 and described above, RMS 500 may include a RMS server 510 including an IO circuit 511, processing unit 512, computer readable medium 513, memory 514, and database 517, wherein each component is in communication with the other components. The RMS server 510 may be operatively connected to a user input device 515 and display device 516. In another embodiment, the system architecture of RMS 500 does not include RMS server 510. In each embodiment IO circuit 511, processing unit 512, computer readable medium 513, memory 514, user input device 515, display device 516, and database 517 are communicatively coupled to each other and to digital network 100.

IO circuit 511 may operatively connect processing unit 512, computer readable medium 513, memory 514, user input device 515, display device 516, and database 517 to digital network 100 to perform various functions described herein. Although FIG. 5 illustrates IO circuit 511 as a single IO circuit, it should be appreciated that IO circuit 511 may include multiple IO circuits. Moreover, although FIG. 5 illustrates IO circuit 511 as a single block, it should be appreciated that IO circuit 511 may include a number of different types of IO circuits.

IO circuit 511 may be in communication with processing unit 512. Processing unit 512 may be adapted and configured to execute various software applications and components of networked system 1 including, for example, software applications including software instructions to remotely monitor networked system 1, including during its operation of the methods illustrated in FIG. 7. For example, processing unit 512 may be adapted and configured to execute software applications 513A and 513B, for example, as described more fully below, to monitor, log, and implement security measures of networked system 1; to send and receive patient satisfaction surveys to, for example, determine the patient satisfaction rating of first health care provider 300 and each of the second health care providers 305; to complete and log tasks associated with networked system 1; to identify and correct technical issues with networked system 1; to log correspondence read receipts, e.g., correspondence read receipts received from first health care provider 300 and each of the plurality of second health care providers 305; to log download and upload confirmations; to process and log response times of first health care provider 300 and each of the plurality of second health care providers 305; to calculate diagnosis accuracies of first health care provider 300 and each of the plurality of second health care providers 305; etc. It should be appreciated that processing unit 512 may be adapted and configured to execute software applications 513A and 513B to perform other tasks without detracting from the purpose of the invention described herein. Although FIG. 5 illustrates a single processing unit, it should be appreciated that processing unit 512 may include multiple processing units 512.

IO circuit 511 and processing unit 512 may be in communication with computer readable medium 513. Although FIG. 5 illustrates computer readable medium 513 as a single computer readable medium 513, it should be appreciated that computer readable medium 513 may include multiple computer readable media 513. Computer readable medium 513 may include software applications 513A and 513B, which, for example, may provide instructions for execution by processing unit 512 as described above. It should be appreciated that computer readable medium 513 may include more or less software applications than 513A and 513B yet remain configured to provide instructions necessary for networked system 1 to perform the functions described herein.

In one embodiment, software application 513A may allow RMS 500 to perform tasks associated with a remote monitoring system. While software application 513A is depicted in FIG. 5 as a single module, software application 513A may include any number of modules accomplishing tasks related to the operations of remote monitoring systems, including for example, receiving and sending e-mails; performing tasks related to customer service and technical support; performing statistical analyses using various software applications, e.g., R, SAS, and Excel.

In another embodiment, software application 513B may be an interface application for allowing RMS 500, for example, by use of user input device 515 and display device 516, to input and view data associated with intermediary server 400 and networked system 1. For example, software application 513B may allow RMS 500 to monitor, log, and implement security measures of networked system 1; to send and receive patient satisfaction surveys to, for example, determine the patient satisfaction rating of first health care provider 300 and each of the second health care providers 305; to complete and log tasks associated with networked system 1; to identify and correct technical issues with networked system 1; to log correspondence read receipts, e.g., correspondence read receipts received from first health care provider 300 and each of the plurality of second health care providers 305; to log download and upload confirmations; to process and log response times of first health care provider 300 and each of the plurality of second health care providers 305; to calculate diagnosis accuracies of first health care provider 300 and each of the plurality of second health care providers 305. It should be appreciated that software application 513B may be adapted and configured to allow RMC 500 to perform other various tasks without detracting from the purpose of the invention described herein.

In one embodiment, software application 513B is a web browser client. However, it should be appreciated that software application 513B may be any type of interface application, including a proprietary interface, and may communicate with networked system 1 using any type of protocol including, but not limited to, file transfer protocol (FTP), telnet, hypertext-transfer protocol (HTTP), hypertext-transfer protocol secure (HTTPS), etc., that will allow RMS 500 to interface with networked system 1, and in particular intermediary server 400, to perform the foregoing tasks. While software application 513B is depicted in FIG. 5 as a single module, software application 513B may include any number of modules accomplishing the foregoing described tasks.

IO circuit 511, processing unit 512, and computer readable medium 513 may be in communication with a memory 514. Although FIG. 5 illustrates a single memory 514, it should be appreciated that the RMS 500 may include multiple memories 514. Memory 514 may be used for storage and retrieval of information and data associated with software applications 513A and 513B of computer readable medium 513.

As described above, RMS 500 may further include a user input device 515, display device 516, and database 517. IO circuit 511, processing unit 512, computer readable medium 513, and memory 514, may be in communication with user input device 515, display device 516, and database 517. User input device 515, display device 516, and database 517 may be adapted and configured in a manner similar to, for example, user input device 315, display device 316, and database 317, as described above and illustrated in FIG. 3. Database 517 may allow for storage of data and information, including, among other things, the first, second, and third health care records of first person 200; data and information related to diagnosis accuracies of first health care provider 300 and each of the plurality of second health care providers 305; data and information related to patterns in diagnoses of first health care provider 300 and each of the plurality of second health care providers 305; patient satisfaction ratings of first health care provider 300 and each of the plurality of second health care providers 305; de-identified health care data and information, i.e., data and information that does not identify a particular first person 200; correspondence read receipts, e.g., correspondence read receipts received from first health care provider 300 and each of the plurality of second health care providers 305; download and upload confirmations; data and information related to response times of first health care provider 300 and each of the plurality of second health care providers 305. It should be appreciated that database 517 may allow for storage of other data and information related to the operation of RMS 500 without detracting from the scope of the invention described herein.

FIG. 7 illustrates a flow chart for a method implemented by networked system 1. Intermediary server 400 may transmit (via network 100) a query to first health care provider 300 requesting the receipt of a first health care record of first person 200, as illustrated by numeral 701. As described above, the first health care record may include, among other data and information, a diagnosis and recommended treatment, if any, of a first health care provider such as first health care provider 300.

As illustrated by numeral 702 of FIG. 7, intermediary server 400 may receive (over digital network 100) a first health care record of first person 200. In one embodiment, intermediary server 400 receives the first health care record of first person 200 from the health care provider 300, which transmits the first health care record over digital network 100 in response to the query described above (with reference to numeral 701).

After receipt of the first health care record from, for example, first health care provider 300, intermediary server 400 may be ready to transmit the first health care record to a plurality of second health care providers 305 over digital network 100. Numeral 703 illustrates that intermediary server 400 may query the first person 200 (via digital network 100) for instructions regarding the transmission of the first health care record. As described above, FIG. 6 illustrates one embodiment regarding the transmission of instructions by first person 200 over digital network 100. As described above, the instructions from first person 200 may include instructions 601′ to intermediary server 400, which identify the plurality of second health care providers 305 which should receive the first health care record of the first person 200. As illustrated by numeral 704, intermediary server 400 may receive (via digital network 100) those instructions from first person 200.

Numeral 705 illustrates intermediary server determining whether the instructions received from first person 200 identify a particular second health care provider 305. If the instructions do not identify a particular second health care provider 305, intermediary server 400 does not transmit the first health care record to that particular second health care provider 305 (as illustrated by numeral 706). If the instructions do identify a particular second health care provider 305, intermediary server 400 does transmit (via digital network 100) the first health care record to each of the second health care providers 305 identified in the instructions from the first person 200 (as illustrated by numeral 707).

As described above, after receiving the first health care record from intermediary server 400 over digital network 100, each of the plurality of second health care providers 305 may create a second health care record. As described above, the second health care record may include information that is supplemental to the first health care record. For example, each of the second health care providers 305 may include in the second health care record their “second opinion,” including a diagnosis and recommended treatment associated with first person 200. As described above, intermediary server 400 may be adapted and configured to receive a second health care record from the plurality of second health care providers 305.

As described above, FIG. 6 illustrates one embodiment regarding the transmission of instructions by first person 200 over digital network 100. As described above, the instructions from first person 200 may include instructions 602′ to intermediary server 400, which may identify whether first person 200 or first health care provider 300 should receive the plurality of second health care records from the plurality of second health care providers 305.

Numeral 708 illustrates that intermediary server 400 may query (via digital network 100) each of second health care providers 305 for a second health care record of first person 200. Intermediary server 400 may then, as illustrated by numeral 709, receive (over digital network 100) a plurality of second health care records of first person 200 from the plurality of second health care providers 305.

As described above, intermediary server 400 may create a third health care record of first person 200 based on at least a portion of the plurality of second health care records received from the plurality of second health care providers 305. Before creating the third health care record, as illustrated by numeral 710, intermediary server 400 may test for significant differences among the plurality of second health care records. For example, and as described above, intermediary server 400 may test for significant differences among diagnoses and recommended treatments provided by each of the plurality of second health care providers 305 in the plurality of second health care records. Intermediary server 400 may do this by, for example, using statistical algorithms such as the Kappa statistic, described above, and modified versions thereof. Numeral 711 illustrates intermediary server 400 creating the third health care record of first person 200. As described above, the third health care record of first person 200 may be based on at least a portion of the plurality of second health care records. The third health care record may include some or all of the data and information contained in the first and second health care records.

After intermediary server 400 has created the third health care record of first person 200, it may be ready to transmit the third health care record. As described above, including with reference to the description of FIG. 6, first person 200 may provide instructions to intermediary server 400 regarding the transmission of the third health care record and, in particular, instructions identifying to whom intermediary server 400 should transmit the third health care record. This is illustrated in FIG. 6 as instructions 603 transmitted over digital network 100 to intermediary server 400. Numeral 712 of FIG. 7 illustrates intermediary server 400 querying (via network 100) first person 200 for instructions regarding the transmission of the third health care record. Numeral 713 illustrates intermediary server 400 determining whether the instructions received from first person 200 identify first person 200, first health care provider 300, or each of the plurality of second health care providers 305. If the instructions do not identify first person 200, first health care provider 300, or each of the plurality of second health care providers 305, intermediary server 400 does not transmit the third health care record to the entity not identified by the instructions received from first person 200 (as illustrated by numeral 714). If the instructions do identify the first person 200, first health care provider 300, or each of the second health care providers 305, intermediary server 400 does transmit (via digital network 100) the third health care record to each of first person 200, first health care provider 300, and each of the plurality of second health care providers 305 that were identified by the instructions received from first person 200.

FIG. 7 illustrates several steps of a method that may be performed by networked system 1. However, it should be appreciated that more or fewer steps may be performed by networked system 1, including by intermediary server 400, without detracting from purpose of the invention described herein. It should further be appreciated that intermediary server 400 may perform some or all of the steps of the method implemented by networked system 1. As described above, the use of intermediary server 400 may increase data processing and storage capacity of first person 200 (and their communications device 210), first health are provider 300, and each of the plurality of second health care providers 305, by allowing each entity's system architecture retain storage space and process less data, thereby increasing processing speed and efficiency. As described above, the use of intermediary server 400 may further increase the security of networked system 1.

The following describes one example of a typical use of the systems and methods of the present invention. By way of example, a first person 200 who has suffered from a torn ankle ligament may be experiencing symptoms of pain and swelling. As a result, the person may schedule a visit with a primary care physician (in this case, first health care provider 300). The primary care physician may create a first health care record including, among other things, basic patient information such as contact information and medical history. The first health care record may further include data and information, such as test results of procedures performed by first health care provider 300. The first health care record may further include the medical opinion, including diagnosis and recommended treatment, of first person 200's ankle injury. In this example, the first health care record may include an x-ray of the ankle of first person 200 and further indicate that first person 200 has an ankle sprain, and that the recommended treatment is to take anti-inflammatory medication, e.g., ibuprofen, ice the affected ankle to reduce the swelling, and rest the ankle. In this example, the first health care record includes both a misdiagnosis (ankle sprain) and an improper recommended treatment (ice, rest, and anti-inflammatory medication).

First person 200 may not be satisfied with the medical opinion of the primary care physician (first health care provider 300), including the physician's diagnosis and recommended treatment, and may thereby decide to seek one or more second medical opinions. Alternatively, first person 200 may listen to the opinion of first health care provider 300 and perform the recommended treatment of first health care provider 300, i.e., ice, rest, and anti-inflammatory medication. However, after several weeks of the recommended treatment, which did not include the proper treatment for a torn ankle ligament, first person 200 may still experience symptoms of ankle pain and swelling. In this example, first person 200 may again decide to seek one or more second medical opinions.

Using networked system 1 described herein, intermediary server 400 may query, or otherwise remind or request, first health care provider 300 over digital network 100 for receipt of the first health care record (illustrated by numeral 701 in FIG. 7). Intermediary server 400 may thereafter receive first person 200's first health care record (illustrated by numeral 702 in FIG. 7). As described above, first person 200 may provide instructions, such as instructions 601 and 601′ as illustrated in FIG. 6, to first health care provider 300 or intermediary server 400 concerning which of a plurality of second health care providers 305 should receive a copy of the first health care record (illustrated by numeral 704 in FIG. 7). Intermediary server 400 may query first person 200 for receipt of those instructions (illustrated by numeral 703 in FIG. 7). In this example, first health care provider 300 may select a number of second health care providers 305 that first person 200 would like to provide a second medical opinion based on their review of the first health care record. For example, first person 200 may select a second primary care physician, a specialist in orthopedics, and a specialist in sports medicine, each of which would be considered a second health care provider 305 in this example. It should be appreciated that first person 200 may select any number of second health care providers 305.

After receipt of the instructions from first person 200, intermediary server 400 may process which second health care providers 305 to transmit the first health care record (illustrated by numerals 705 and 706 in FIG. 7), and thereafter transmit the first health care record (illustrated by numeral 707 in FIG. 7).

After receipt of the first health care record, each of the plurality of second health care providers 305 may review the first health care record and provide a second medical opinion based on their review of the first health care record. In this example, the second health care providers 305 may create a second health care record that may include data and information supplemental to the first health care record, including a diagnosis and recommended treatment that may be different than that provided by first health care provider 300. For example, the specialist in orthopedics may create a second health care record that includes a diagnosis of a torn ankle ligament needing surgery as the recommended treatment. The second primary care physician may create a second health care record that includes a diagnosis and recommended treatment that is the same as that of first health care provider 300, i.e., a sprained ankle (diagnosis) needing ice, rest, and anti-inflammatory medication (recommended treatment). The specialist in sports medicine may create a second health care record that includes a diagnosis of a torn ankle ligament needing surgery as the recommended treatment. Accordingly, in this example, first person 200 may receive a plurality of second health care records, including second medical opinions, e.g., diagnoses and recommended treatments, without scheduling, traveling to, and paying for a plurality of second medical consultations. Further, and as illustrated above, the plurality of second health care records may include both the correct diagnosis and recommended treatment, e.g., torn ankle ligament and surgery, and the incorrect diagnosis and recommended treatment.

First person 200 may transmit instructions, such as instructions 602 and 602′ illustrated in FIG. 6, concerning to whom the plurality of second health care records should be sent, i.e., first person 200, intermediary server 400, and/or first health care provider 300. In this example, intermediary server 400 may query the plurality of second health care providers 305 for each of their second health care records (illustrated by numeral 708 in FIG. 7), and thereafter receive the second health care records over digital network 100 (illustrated by numeral 709 in FIG. 7).

After receiving the plurality of second health care records from each of the plurality of second health care providers 305, intermediary server may test for significant differences among the various second health care records (illustrated by numeral 710 of FIG. 7), including test for significant differences among the various diagnoses and recommended treatments of each of the second health care providers 305. For example, and as described above, intermediary server 400 may test for significant differences by using statistical algorithms such as the Kappa equation and modified versions thereof. The test for significant differences may allow intermediary server 400 to determine the correct diagnosis and/or appropriate recommended treatment based on whether differences between that diagnosis and/or recommended treatment and other diagnoses and recommended treatments are statistically significant. Intermediary server 400 may then create a third health care record of first person 200. The third health care record may be based at least on a portion of each of the second health care records (illustrated as numeral 711 in FIG. 7). In this example, the third health care record may include names of each of the second health care providers 305, along with their corresponding diagnoses and recommended treatments. The third health care record may further include the results of the test for significant differences (illustrated as numeral 710 in FIG. 7). If the test for significant differences resulted in a correct diagnosis or recommended, as described above, the third health care record may include the correct diagnosis and recommended treatment.

In this example, intermediary server 400 may test for significant differences among the diagnoses and recommended treatments of the specialist in orthopedics, second primary care physician, and specialist in sports medicine. Accordingly, intermediary server 400 may determine that the diagnosis of torn ankle ligament is most likely correct and that the recommended treatment of ankle surgery to fix the torn ankle ligament is most likely the appropriate recommended treatment. Intermediary server 400 may create a third health care record, similar to the third health care record illustrated in FIG. 8, for identifying the specialist in orthopedics, second primary care physician, and specialist in sports medicine, along with each of their medical opinions derived from their second health care records, including their diagnoses and recommended treatments. Intermediary server 400 may further identify the results from the test for significant differences, including identify the correct diagnosis and recommended treatment.

As described above with reference to FIG. 6, first person 200 may provide instructions regarding the transmission of the third health care record (illustrated by numeral 713 in FIG. 7), such as instructions 603 illustrated in FIG. 6, including identifying whether first person 200, first health care provider 300, and each of the plurality of second health care providers 305 shall receive the third health care record. Intermediary server 400 may query for the receipt of these instructions from first person 200 (illustrated by numeral 712 in FIG. 7).

In this example, first person 200 may provide instructions identifying only first person 200 to receive the third health care record. Intermediary sever 400 may process those instructions and transmit the third health care record only to first person 200 according to those instructions (illustrated by numerals 713, 714, and 715).

With receipt of the third health care record, first person 200 may thereafter determine the appropriate action. In this example, first person 200 may determine that first person 200 has a torn ankle ligament and that first person 200 should get surgery on their ankle for treatment, as recommended by the third health care record. First person 200 may elect to schedule an appointment with the specialist in orthopedics or the specialist in sports medicine to perform the needed surgery, each of which correctly diagnosed first person 200 with a torn ankle ligament and recommended the appropriate surgical treatment. Alternatively, first person 200 could provide the third health care record, and any of the first or second health care records, to a different health care provider for further review and treatment.

Without the advantages provided by the present invention, as described above, first person 200 would have been burdened by the time, expense, and health risk associated with seeking a plurality of second medical opinions. For example, first person 200 may have decided to not seek a plurality of second medical opinions. If first person 200 did not seek a plurality of second medical opinions, first person 200 may have continued to believe that they suffered from a sprained ankle, as diagnosed by first health care provider 300. Accordingly, first person 200 could have wasted significant time with the incorrect diagnosis and recommended treatment.

This may have caused first person 200 significant harm, including unnecessary pain during the period of delay before learning of the correct diagnosis. Although the above example concerns a torn ankle ligament, there are many other medical conditions that may present more significant burden, expense, and health safety risks if they are not properly diagnosed in the first instance, or by a plurality of second medical opinions facilitated by networked system 1.

By using networked system 1 of the present invention to facilitate receipt of a plurality of second opinions, first person 200 obtained the correct diagnosis, i.e., torn ankle ligament, and correct recommended treatment, i.e., ankle surgery, without scheduling numerous visits with second health care providers, thereby reducing burden, expense, and associated risks to the person's health and safety.

A second example of a typical use of the systems and methods of the present invention is for use in education within the healthcare field including, for example, medical school and/or medical residencies. In this example, an educational institution or instructor may be collaborating with first person 200. First person 200 may be a real person, e.g., a case study of a person having real injuries and/or ailments, or a hypothetical person with hypothetical injuries and/or ailments. A healthcare student may be a first health care provider 300, who may create a first health care record including a diagnosis and recommended treatment of first person 200's injuries or ailments. Other healthcare students, healthcare professionals, and/or instructors, may be second health care providers 305, each of which may create a second health care record including diagnosis and recommended treatment that may be different than that provided by first health care provider 300. By using the systems and methods of the present invention, an educational institution or instructor may encourage collaborative learning among its health care students. Further, by using the systems and methods of the present invention, educational institutions or instructors may more effectively and accurately monitor the training and progress of its healthcare students.

For example, using the systems and methods of the present invention allows a first health care provider 300, in this case a health care student, create a first health record of first person 200 including their diagnosis and recommended treatment. First health care provider 300 may also receive a plurality of second health care records including the diagnoses and recommended treatments of second health care providers 305. The second health care records may differ from the first health care record of the first health care provider 300. In this regard, the first health care provider 300 may learn through receiving and reviewing differing health care records provided by a plurality of second health care providers 305.

By way of further example, using the systems and methods of the present invention allows an educational institution or instructor, who may be collaborating with first person 200, to receive a plurality of first health care records created by first health care providers 300 (which may be health care students) and a plurality of second health care records created by a plurality of second health care providers 305 (which may also be health care students). In this regard, by using the systems and methods of the present invention, educational institutions or instructors may more effectively and accurately monitor the training and progress of its healthcare students.

Aspects of the techniques described herein may be implemented in digital electronic circuitry, computer software, firmware, or hardware, including the structures disclosed herein and their structural equivalents, or in various combinations. Aspects of the techniques described herein may be implemented as one or more computer programs, for example, one or more sets of program instructions residing on or encoded in a computer-readable storage medium for execution by, or to control the operation of, one or more processing units. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processing units. A computer-readable medium may be, or be included in, a computer-readable storage device, a computer-readable storage substrate, a random or serial access memory array or device, various combinations thereof. Moreover, while a computer-readable medium may or may not be a propagated signal, a computer-readable medium may be a source or destination of program instructions encoded in an artificially-generated propagated signal. The computer-readable medium may also be, or be included in, one or more separate physical components or media (for example, CDs, disks, or other storage devices).

Certain techniques described in this specification may be implemented as operations performed by one or more processing units on data stored on one or more computer-readable mediums or received from other sources. The term “processing unit” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processing unit may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processing units located at one site or distributed across multiple sites connected by a network.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A system for distributing a person's health care records to a plurality of health care providers to facilitate the receipt of a plurality of medical opinions, the system comprising:
a communications network;
at least one first server communicatively coupled to the communications network and capable of storing a first health care record of a first person received from a first health care provider;
a plurality of second servers communicatively coupled to the communications network and each capable of storing a second health care record of the first person, wherein at least a portion of each stored second health care record includes health care information supplemental to the first health care record;
at least one third server, the third server including a processor coupled to a memory having an application stored thereon, communicatively coupled to the communications network and the at least one first server and the plurality of second servers, the application configured to cause the third server to:
receive over the communications network at the third server the first health care record of the first person from the at least one first server;
transmit the first health care record over the communications network to the plurality of second servers;
receive over the communications network at the third server a plurality of second health care records from the plurality of second servers;
create a third health care record of the first person based on at least a portion of the plurality of second health care records; and
transmit the third health care record over the communications network to at least one of the first health care provider, each second health care provider that transmitted a second health care record, and the first person.

2. The system of claim 1, wherein
the application is further configured to cause the third server to receive over the communications network at the third server instructions from the first person identifying the plurality of second servers to which the third server will transmit the first health care record.

3. The system of claim 1, wherein
the application is further configured to cause the third server to receive over the communications network at the third server instructions from the first person identifying the at least one of the first health care provider, each second health care provider that transmitted a second health care record, and the first person to which the third server will transmit the third health care record.

4. The system of claim 1, wherein
the application is further configured to cause the third server to receive over the communications network at the third server
instructions from the first person identifying the plurality of second servers to which the third server will transmit the first health care record; and
instructions from the first person identifying the at least one of the first health care provider, each second health care provider that transmitted a second health care record, and the first person to which the third server will transmit the third health care record.

5. The system of claim 1, wherein
the application is further configured to cause the third server to query over the communications network the at least one first server for receipt of the first health care record.

6. The system of claim 1, wherein
the application is further configured to cause the third server to query over the communications network the plurality of second servers for receipt of the plurality of second health care records.

7. The system of claim 1, wherein
the application is further configured to cause the third server to query over the communications network
the at least one first server for receipt of the first health care record; and
the plurality of second servers for receipt of the plurality of second health care records.

8. The system of claim 1, wherein
the application is further configured to cause the third server to
test for significant differences among the plurality of second health care records; and
create the third health care record of the first person based at least in part by the test for significant differences among the plurality of second health care records.

9. The system of claim 1, wherein
the application is further configured to cause the third server to
receive over the communications network at the third server
instructions from the first person identifying the plurality of second servers to which the third server will transmit the first health care record; and
instructions from the first person identifying the at least one of the first health care provider, each second health care provider that transmitted a second health care record, and the first person to which the third server will transmit the third health care record;
query over the communications network
the at least one first server for receipt of the first health care record; and
the plurality of second servers for receipt of the plurality of second health care records;
test for significant differences among the plurality of second health care records; and
create the third health care record of the first person based at least in part by the test for significant differences among the plurality of second health care records.

10. A method for distributing a person's health care records to a plurality of health care providers to facilitate the receipt of a plurality of medical opinions, the method comprising:
receiving over a communications network at a server, the server including a processor coupled to a memory having an application stored thereon, a first health care record of a first person from a first health care provider;
causing the server to transmit the first health care record over the communications network to a plurality of second health care providers;
receiving over the communications network at the server a plurality of second health care records of the first person received from the plurality of second health care providers,
wherein at least a portion of each received second health care record includes health care information supplemental to the first health care record;
causing the server to create a third health care record of the first person based on at least a portion of the plurality of second health care records; and
causing the server to transmit the third health care record over the communications network to at least one of the first health care provider, each second health care provider that transmitted a second health care record, and the first person.

11. The method of claim 10, further comprising the step of:
receiving over the communications network at the server instructions from the first person identifying the plurality of second health care providers to which the server will transmit the first health care record.

12. The method of claim 10, further comprising the step of:
receiving over the communications network at the server instructions from the first person identifying the at least one of the first health care provider, each second health care provider that transmitted a second health care record, and the first person to which the server will transmit the third health care record.

13. The method of claim 10, further comprising the step of:
receiving over the communications network at the server instructions from the first person identifying the plurality of second health care providers to which the server will transmit the first health care record; and
receiving over the communications network at the server instructions from the first person identifying the at least one of the first health care provider, each second health care provider that transmitted a second health care record, and the first person to which the server will transmit the third health care record.

14. The method of claim 10, further comprising the step of:
causing the server to query over the communications network the first health care provider for receipt of the first health care.

15. The method of claim 10, further comprising the step of:
causing the server to query over the communications network the plurality of second health care providers for receipt of the plurality of second health care records.

16. The method of claim 10,
causing the server to query over the communications network the first health care provider for receipt of the first health care record; and
causing the server to query over the communications network the plurality of second health care providers for receipt of the plurality of second health care records.

17. The method of claim 10, further comprising the step of:
causing the server to test for significant differences among the plurality of second health care records; and
causing the server to create the third health care record of the first person based at least in part by the test for significant differences among the plurality of second health care records.

18. The method of claim 10, further comprising the steps of:
causing the server to query over the communications network the first health care provider for receipt of the first health care record; and
receiving over the communications network at the server instructions from the first person identifying the plurality of second health care providers to which the server will transmit the first health care record;
causing the server to query over the communications network the plurality of second health care providers for receipt of the plurality of second health care records;
causing the server to test for significant differences among plurality of second health care records;
causing the server to create the third health care record of the first person based at least in part by the test for significant differences among the plurality of second health care records; and
receiving over the communications network at the server instructions from the first person identifying the at least one of the first health care provider, each second health care provider that transmitted a second health care record, and the first person to which the server will transmit the third health care record.

19. At least one computer-readable medium including instructions executable to cause a system to perform operations comprising:
receiving over a communications network at a server, the server including a processor coupled to a memory having an application stored thereon, a first health care record of a first person from a first health care provider;
causing the server to transmit the first health care record over the communications network to a plurality of second health care providers;
receiving over the communications network at the server a plurality of second health care records of the first person received from the plurality of second health care providers,
wherein at least a portion of each received second health care record includes health care information supplemental to the first health care record;
causing the server to create a third health care record of the first person based on at least a portion of the plurality of second health care records; and
causing the server to transmit the third health care record over the communications network to at least one of the first health care provider, each second health care provider that transmitted a second health care record, and the first person.

20. The at least one computer-readable medium of claim 19 further including instructions executable to cause a system to perform operations comprising:
receiving over the communications network at the server instructions from the first person identifying the plurality of second health care providers to which the server will transmit the first health care record.

21. The at least one computer-readable medium of claim 19 further including instructions executable to cause a system to perform operations comprising:
receiving over the communications network at the server instructions from the first person identifying the at least one of the first health care provider, each second health care provider that transmitted a second health care record, and the first person to which the server will transmit the third health care record.

22. The at least one computer-readable medium of claim 19 further including instructions executable to cause a system to perform operations comprising:
receiving over the communications network at the server instructions from the first person identifying the plurality of second health care providers to which the server will transmit the first health care record; and
receiving over the communications network at the server instructions from the first person identifying the at least one of the first health care provider, each second health care provider that transmitted a second health care record, and the first person to which the server will transmit the third health care record.

23. The at least one computer-readable medium of claim 19 further including instructions executable to cause a system to perform operations comprising:
causing the server to query over the communications network the first health care provider for receipt of the first health care.

24. The at least one computer-readable medium of claim 19 further including instructions executable to cause a system to perform operations comprising:
causing the server to query over the communications network the plurality of second health care providers for receipt of the plurality of second health care records.

25. The at least one computer-readable medium of claim 19 further including instructions executable to cause a system to perform operations comprising:
causing the server to query over the communications network the first health care provider for receipt of the first health care record; and
causing the server to query over the communications network the plurality of second health care providers for receipt of the plurality of second health care records.

26. The at least one computer-readable medium of claim 19 further including instructions executable to cause a system to perform operations comprising:
causing the server to test for significant differences among the plurality of second health care records; and
causing the server to create the third health care record of the first person based at least in part by the test for significant differences among the plurality of second health care records.

27. The at least one computer-readable medium of claim 19 further including instructions executable to cause a system to perform operations comprising:
causing the server to query over the communications network the first health care provider for receipt of the first health care record; and
receiving over the communications network at the server instructions from the first person identifying the plurality of second health care providers to which the server will transmit the first health care record;
causing the server to query over the communications network the plurality of second health care providers for receipt of the plurality of second health care records;
causing the server to test for significant differences among plurality of second health care records;
causing the server to create the third health care record of the first person based at least in part by the test for significant differences among the plurality of second health care records; and
receiving over the communications network at the server instructions from the first person identifying the at least one of the first health care provider, each second health care provider that transmitted a second health care record, and the first person to which the server will transmit the third health care record.
